(19) United States
(12) Patent Application Publication
(10) Pub. No.: US 2017/0259869 A1
(43) Pub. Date: Sep. 14, 2017

(54) Tandem Bicycle

(71) Applicant: Shawn C. Raymond, Palo Alto, CA (US)

(72) Inventor: Shawn C. Raymond, Palo Alto, CA (US)

(21) Appl. No.: 15/606,606

(22) Filed: May 26, 2017

Related U.S. Application Data
(63) Continuation-in-part of application No. 14/997,193, filed on Jan. 15, 2016, now abandoned.
Application No. 14/997,193 is a continuation of application No. 14/376,215, filed on Aug. 1, 2014, now Pat. No. 9,254,882.
(60) Provisional application No. 61/593,718, filed on Feb. 1, 2012.

(51) Int. Cl. B62K 3/14; B62M 9/00; B62K 3/12; B62M 1/36

(52) U.S. Cl. CPC B62K 3/14; B62M 1/36; B62K 3/12; B62M 9/00

(57) ABSTRACT

A bicycle is provided that can include front and rear wheels; a handle bar; and top, bottom, head, front seat, and rear seat tube members (each with a longitudinal axis) that form a frame that is suspended between the wheels. A distance between the head tube member and the front seat tube member can be 14 inches or less. The distance can also be one-half or less of the distance between the head tube member and the rear seat tube member. The longitudinal axis of the head tube member can intersect a longitudinal axis of the front seat tube member at 120 inches or less above a riding surface. The rotational planes of the front pedals of a front crankset can overlap a rotational plane of the front wheel. The handle bar rotates about a volume representative of an upper body of a front rider and/or cargo.

### CROSS-REFERENCE TO RELATED APPLICATIONS

The present application is a continuation in-part of U.S. application Ser. No. 14/997,193 filed on 15 Jan. 2016, which is a continuation of U.S. application Ser. No. 14/376,215 filed on 1 Aug. 2014 (now U.S. Pat. No. 9,254,882), which is a national stage filing under 35 USC 371 of International Application No. PCT/US2013/024315, filed on 1 Feb. 2013, which claims priority to U.S. Provisional Application Ser. No. 61/593,718, filed 1 Feb. 2012. The entire disclosures of these prior applications are incorporated herein by this reference.

### TECHNICAL FIELD

The present invention in general relates to bicycles, and in particular to improvements in tandem bicycles.

### BACKGROUND OF THE DISCLOSURE

The tandem bicycle is a form of bicycle designed to be ridden by more than one person. The term tandem refers to the seating arrangement that is fore to aft, not side-by-side. Compared to a conventional bicycle, a tandem has double the pedaling power with only slightly more frictional loss in the drivetrain. Tandem bicycles have about the same wind resistance as a conventional bicycle. High-performance tandems may weigh less than twice as much as a single bike, so the power-to-weight ratio may be slightly better than that of a single bike and rider. On flat terrain and downhill, most of the power produced by cyclists is used to overcome wind resistance, so tandems can reach higher speeds than the same riders on single bicycles. However, tandem bicycles may be slower on climbs, in part due to the need for a high level of coordination between the riders, especially if the physical abilities of the two riders are very different, requiring a compromise on cadence.

In conventional tandems, the front rider steers as well as pedals the bicycle and is also known as the captain, pilot, or steersman; the rear rider only pedals and is also known as the stoker, navigator, or rear admiral. On most tandems two sets of cranks are mechanically linked by a timing chain and turn at the same rate. The transfer of power from all pedals to the rear wheel requires a drive train. Typically, the front most crankset turns the timing chain, which in turn connects to the rear crankset, which transfers this power to the drive chain that connects to the rear wheel. This configuration is called crossover rear drive, and requires both of the rear riders crank arms to have chain rings mounted. Tandem riders may choose to synchronize their pedaling through in-phase (IP) or out-of-phase (OOP) pedaling. In in-phase pedaling, each rider's cranks are in the same or opposite clock positions at any point in time. In out-of-phase pedaling, both riders have their cranks in differing non-opposite positions.

Bicycles, including tandem versions, are built on a frame to which wheels and other components are fitted. The frame is typically constructed from a series of tubes arranged as 5 triangles. A diamond frame 10 typically is formed of two triangles, as shown in prior art FIG. 1, a main triangle 12 and a paired rear triangle 14. The main triangle 12 has a head tube 16, top tube member 18, down tube 20, and seat tube 22. The rear triangle 14 includes the seat tube 22, and paired chain stays 24 and seat stays 26. The head tube member 16 contains the headset, the steering bearings for the fork 28 via the steerer tube, and interfaces with the steering handlebars 30. The fork 28 secures the steerable front wheel 32, while the junction of the chain stays 24 and seat stays 26 acts as an attachment point for the rear wheel 34. The top tube member 18, or cross-bar, connects the top of the head tube member 16 to the top of the seat tube 22. The seat tube 22 accommodates the post 36 from the seat 38 or saddle.

Traditional tandem bicycles have certain drawbacks that include a long wheelbase that reduces the portability and maneuverability of the bicycle, as well as storage and transport of the bicycle. The rear rider of a tandem bicycle has no control over the steering of the bicycle, and in general the forward field of vision of the rear rider is impaired by the front rider. Furthermore, besides reducing the rear rider's view, the seating arrangement of a tandem bicycle also separates the riders from each other so that they cannot interact or communicate easily. The separation of the riders on a tandem bicycle is a serious detriment for social or leisure riding. In fact, riders on a tandem bicycle may feel more isolated from one another than if they were riding side-by-side on separate standard bicycles. The lack of the rear rider's control, sense of participation, and separation from their fellow rider is potentially detrimental to their experience of riding a tandem bicycle.

An example of a short tandem that can be ridden by a single rear rider is known for example as the “BUDDY BIKE™” with the first distance between the head tube and front seat post is typical or near Union Cycliste Internationale (UCI) standard teachings, rather the short length of said tandem types is derived by shortening the second distance between the front seat tube and rear seat tube compared to standard length tandems. The short tandem BUDDY BIKE™ has a front distance that is 17 percent greater than the rear distance. While a standard UCI racing tandem has a first distance of 75-90 percent of the second distance. The UCI tandem's first distance is typical of all bicycle prior art. The UCI tandem are not like short tandems, and the second distance is greater in length due to added space for the rear rider to get into a long aerodynamic body shape, thus the first position would be less. As a result the first distance reduction can be construed to be unrelated to frame shortening technology.

Thus, there exists a need for a more compact and easily transportable tandem bicycle that increases the involvement and participation of the rear rider.

### SUMMARY OF THE DISCLOSURE

A tandem bicycle is provided that is compact and easily transportable, while increasing the involvement and participation of the shorter of the two riders. A tandem bicycle is provided that has a shortened wheelbase between the front and rear wheels that allows a rider to ride comfortably alone from either the front or rear seats, or with a passenger in the front seat. The frame length of a tandem bicycle is comparable to a standard single seat bicycle. The reduced proximity between riders, and the ability to steer from both the front or rear seats on the tandem bicycle improves the level of participation and interaction between the riders. In certain embodiments, the wheelbase is reduced by bringing the front wheel closer to the front seat position. A reduced diameter front wheel is provided to accommodate rotational clearance of the front pedals thereby allowing two riders to ride on bicycle frame with a length common to single rider bicycle.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements. Embodiments are described in detail hereinafter with reference to the accompanying figures, in which:

FIG. 1 illustrates a typical single-rider prior art bicycle frame;

FIG. 2 illustrates a side perspective view of a tandem bicycle according to an embodiment of the invention;

FIG. 3 illustrates a top perspective view of a tandem bicycle according to an embodiment of the invention;

FIG. 4 illustrates a side elevation perspective view of a tandem bicycle according to an embodiment of the invention;

FIG. 5 illustrates a front and rear rider riding the tandem bicycle according to an embodiment of the invention; and

FIG. 6 illustrates a rear rider in the rear seat controlling the tandem bicycle according to an embodiment of the invention.

The detailed description explains the preferred embodiments of the invention, together with advantages and features, by way of example with reference to the drawings.

### DETAILED DESCRIPTION

The disclosure may repeat reference numerals and/or letters in the various examples or Figures. This repetition is for the purpose of simplicity and clarity and does not in itself dictate a relationship between the various embodiments and/or configurations discussed. Further, spatially relative terms, such as beneath, below, lower, above, upper, and the like, may be used herein for ease of description to describe one element or feature's relationship to another element(s) or feature(s) as illustrated, the upward direction being toward the top of the corresponding figure and the downward direction being toward the bottom of the corresponding figure.

Unless otherwise stated, the spatially relative terms are intended to encompass different orientations of the apparatus in use or operation in addition to the orientation depicted in the Figures. For example, if an apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

As used herein, the words “comprise,” “have,” “include,” and all grammatical variations thereof are each intended to have an open, non-limiting meaning that does not exclude additional elements or steps. While compositions and methods are described in terms of “comprising,” “containing,” or “including” various components or steps, the compositions and methods also can “consist essentially of” or “consist of” the various components and steps. It should also be understood that, as used herein, “first,” “second,” and “third,” are assigned arbitrarily and are merely intended to differentiate between two or more objects, etc., as the case may be, and does not indicate any sequence. Furthermore, it is to be understood that the mere use of the word “first” does not require that there be any “second,” and the mere use of the word “second” does not require that there be any “first” or “third,” etc.

The terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

Generally, a tandem bicycle is provided that is compact and easily transportable, while increasing the involvement and participation of the shorter of the two riders. Embodiments of the inventive tandem bicycle have a shortened wheelbase between the front and rear wheels that allows a rider to ride comfortably alone from either the front or rear seats, or with a passenger in the front seat. The frame length of the inventive tandem bicycle is comparable to a standard single seat bicycle. The reduced proximity between riders, and the ability to steer for both the front or rear seats on the inventive tandem bicycle improves the level of participation and interaction between the riders. In embodiments the wheelbase is reduced by bringing the front wheel closer to the front seat position.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

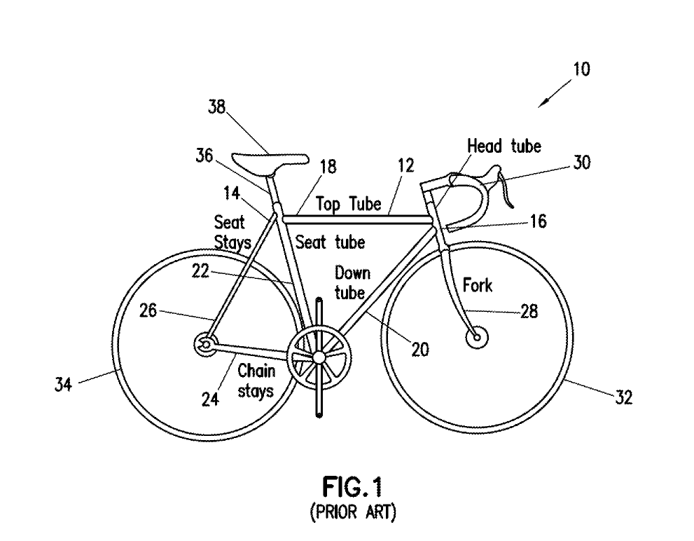

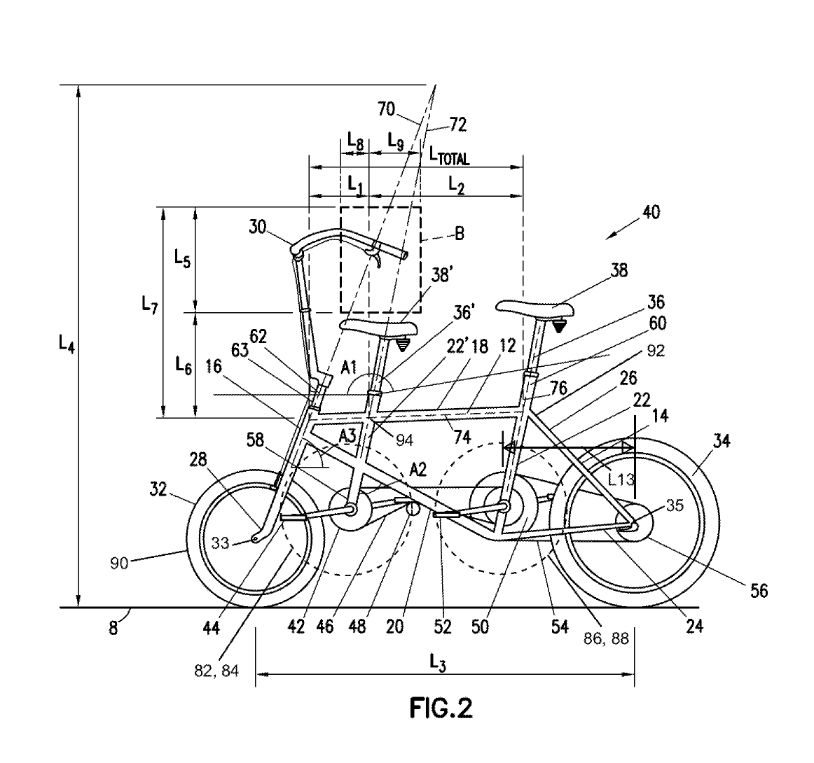

Referring now to FIGS. 2-4 an embodiment of the inventive tandem bicycle is shown generally at 40, with like numbers shared between figures. The embodiment of inventive tandem bicycle 40 is built on a diamond frame 92 consisting of two triangles, as was previously shown in FIG. 1, a main triangle 12 and a paired rear triangle 14. The main triangle 12 consists of the head tube member 16, top tube member 18, down tube member 20, rear seat tube 22, and is bisected by front seat tube 22′. In certain embodiments of the tandem bicycle, the overall length (Ltotal) of the top tube member 18 is comparable to a typical prior art bicycle designed for a single rider per FIG. 1. It is appreciated that in some embodiments, top member 18 is omitted to create greater clearance for a rear rider at the expense of weakened frame 92. In such instances where top tube 18 is omitted, the frame 92 can be strengthened by conventional techniques such as frame material choice or increased tubular diameter for down tube member 20. The top tube member 18 can also be lowered to provide lower clearance for the rear rider to mount and dismount the tandem bicycle. It should be understood that these tubes can be made from any material suitable to support the construction of the frame 92. For example, they can be made from steel, aluminum, titanium, other suitable metals, plastic, composite, wood, etc. They can be made from circular tubing as well as rectangular tubing, various cross-sectional shaped beams, etc. Therefore, as used herein, “tube” or “tubes” refer to a structure that can be used to connect to other structures to form a frame 92 of the tandem bicycle.

As seen in FIG. 2, the overall length (Ltotal) of the top tube member 18 can include two subsections: a first length (L1) from the head tube member 16 to the front seat tube 22′, and a second length (L2) from the front seat tube 22′ to the rear seat tube 22. These distances can measured relative to the intersections of an axis 74 of the top tube member 18 with the axes 70, 72, and 76 of the front, front seat, and rear seat tube members, respectively. It should be understood that the frame 92 can be built without the front seat tube 22′. In this configuration, the position of the front seat tube 22′ can represent where a front mount 94 is positioned to support a clamp-on type front seat (clamps on to the top tube member) or a front mount 94 used to removably attach a cargo support to the top tube member 18 at the location of the front seat tube member 22′. The rear triangle 14 is defined by the rear seat tube 22, and paired chain stays 24 and seat stays 26. The head tube member 16 contains the headset, and the steering bearings for the fork 28 via the stem 62, and interfaces with the steering handlebars 30. The fork 28 secures the steerable front wheel 32, while the junction of the chain stays 24 and seat stays 26 acts as an attachment point for the rear wheel 34. The top tube member 18, or cross-bar, connects the top of the head tube member 16 to the top of the rear seat tube 22 and front seat tube 22′ in certain embodiments, while in other embodiments, the top bar member 18 is omitted or possibly reduced in height from the riding surface 8. The rear seat tube 22 accommodates or engages the post 36 from the rear seat 38 or saddle, while front seat tube 22′ accommodates or engages the post 36′ from the front seat 38′. Both the front seat 38′ and rear seat 38 are removably and adjustably attached to their respective seat tubes 22′ and 22 via seat posts 36′ and 36, respectively.

In certain embodiments, an angle A1 of between 150 and 170 degrees is defined between the horizon for the orientation shown and the line between the tops of posts 36-36′. The bottom of front seat tube 22′ has a downward extension tube 58 extending below the down tube member 20 that is attached to a front bottom bracket to hold and engage a timing or front crankset 42 and front pedals 44, which drives or turns a timing chain 46 suspended with a timing chain adjuster 48, to adjust the timing chain 46. The timing chain 46 in turn connects to the rear crankset 50 attached to rear pedals 52, which transfers this power to the drive chain 54 that connects to the rear wheel 34 via gear set 56. The rear seat tube 22 holds or engages the rear crankset 50 and terminates at the intersection of the down tube 20 and the rear chain stays 24. Together, the timing chain 46 and drive chain 54 form a power transmission that may be operated by a first and a second rider either individually or together, while seated in the front seat 38′, rear seat 38, or both.

The handle bar 30 is movably connected to the head tube member 16 via stem 62 of the tandem frame. In certain inventive embodiments, the stem 62 may be similar to the up and down adjustable stem found on folding bikes, or the stem 62 can have a hinge 63 for easier transportation in a similar fashion to stems used on folding bikes. Additionally, it can be appreciated that the stem 62 may be adjusted to different angles front to back.

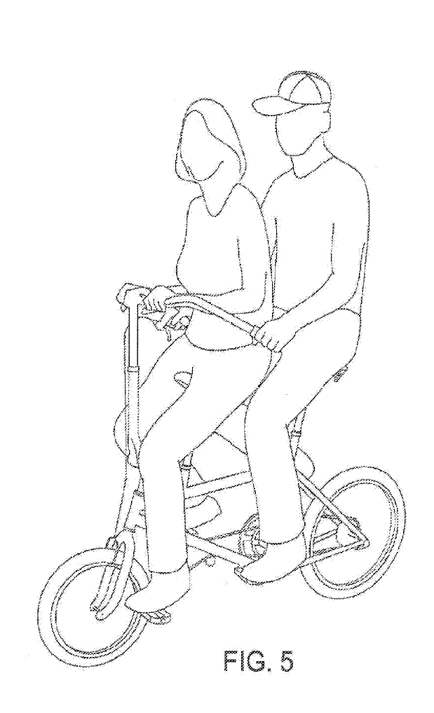

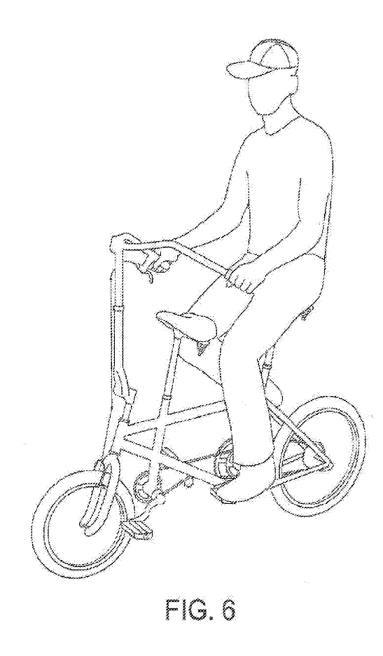

The handle bar 30 is adapted to be manipulated by either at least one of the first or second riders sitting on the front 38′ or rear seat 38 as shown in FIGS. 5 and 6. FIG. 5 illustrates a front and rear rider riding the tandem bicycle. FIG. 6 illustrates a rear rider in the rear seat controlling the tandem bicycle. In certain inventive embodiments, the handle bar 30 includes elongated handle bars adapted to allow a rider positioned on the rear seat 38 to be able to steer from the rear seat 38.

In certain embodiments of the tandem bicycle 40, a first distance (L1) between the head tube member 16 and front seat tube member 22′ is less than 75 percent the length of a second distance (L2) between the rear seat tube member 22 and the front seat tube member 22′. The first distance L1 is measured along the axis 74 of the top tube member 18, from the intersection point of the axis 74 and the axis 70, to the intersection point of axis 74 and the axis 72. The second distance L2 is measured along the axis 74 of the top tube member 18, from the intersection point of the axis 74 and the axis 72, to the intersection point of axis 74 and the axis 76. In still other embodiments, the distance (L1) between the head tube member 16 and said front seat tube member 22′ is less than 50 percent the length of the top tube member 18. The tandem with a first distance being less than 75 percent of the second distance or even less than 50 percent of the second distance, thereby providing advantages of handling, transport, and unparalleled utility for the single rider.

In certain embodiments of the tandem bicycle 40, the distance (L1) between the head tube member 16 and the front seat tube member 22′ is less than 14 inches. In other inventive embodiments, the distance (L1) between the head tube member 16 and the front seat tube member 22′ is 6 inches.

In other embodiments of the tandem bicycle 40, a wheelbase distance (L3) measured from the axis of the front wheel 32 to the axis of the rear wheel 34 is 41.5 inches, and the distance (L1) between the head tube member 16 and the front seat tube member 22′ along the top tube member 18 axis 74 is less than 14 inches.

In other embodiments of the tandem bicycle 40, the diameter of the front wheel 32 is less than the diameter of the rear wheel 34.

In other embodiments of the tandem bicycle 40, the front seat tube member 22′ downward extension tube 58 extends below the down tube member 20, with an angle between the riding surface 8 and the down tube member 20 of greater than 20 degrees.

In other embodiments of the tandem bicycle 40, the rear seat tube member 22 has an upward extension tube 60 above the top tube member 18 that engages the rear seat post 36. The upward tubular extension tube 60 is reinforced and serves as a strengthening member for the rear seat post 36.

In an embodiment of the tandem bicycle 40, the front pedals 44 form a set of left and right pedals for the front seat 38′ that define left and right crank rotational planes 82, 84 (see FIG. 2), and a perpendicular distance L12 between the left and right crank rotational planes 82, 84 can be used to define an allowed diameter of the front wheel 32 to thereby avoid contact between the set of left and right pedals of front pedals 44, or a rider's toes, with the front wheel 32. The position of the front wheel 32 is also determined by the angle A3 of the head tube member 16. The head tube member 16 may be at an angle A3 between 50-80 degrees that allows the front wheel 32 to be positioned within the left and right crank rotational planes 82, 84 of the left and right pedals 44 of the front seat 38′.

In an embodiment of the tandem bicycle 40, a rotational axis 70 of the front tube member 16 can be positioned at the angle A3 relative to the riding surface 80, such that the rotational axis 70 can extend through a spacial volume B positioned above the front seat 38′ as shown in FIG. 2. The spacial volume B indicates a volume that a front rider may occupy when seated on the front seat 38′. The axis 70 extending through the volume B can illustrate how the handle bars 30 are configured to rotate around a front rider sitting on the front seat 38′. Intersection #1 can be defined as the intersection of the axis 70 and the axis 74. Intersection #2 can be defined as the intersection of the axis 72 and the axis 74. Intersection #1 can be defined as the intersection of the axis 76 and the axis 74. The volume B is shown to be positioned a distance L8 in front of the intersection #2, and a distance L9 to the rear of the intersection #2. Distance L5 represents the height of the volume B, with distance L6 indicating the distance from the bottom of the volume B to the axis 74, and L7 indicating the distance from the top of the volume B to the axis 74. FIG. 2 does not show it, but the volume B can be positioned just above the top tube member 18, which can include the top of the front seat tube member 22′ and the front seat 38′.

Distance L4 indicates the point above the riding surface 8 that the axes 70 and 72 can intersect. The height (or distance L4) of the intersection point between axes 70 and 72 demonstrates a relationship between the front seat tube member 22′ and the front tube member 16. With the front seat tube member 22′ positioned closer to the front tube member 16 than other tandem bicycles and the front tube member 16 angled at a greater angle A3 than other tandem bicycles, the wheelbase L3 of the tandem bicycle 40 of the current disclosure can be reduced over the wheelbases of other tandem bicycles, while still providing sufficient clearance for the front rider (generally indicated by the volume B) as well as clearance of the front pedals 44 from the front wheel 32. The distance L4 can be on the order of 120 inches or less, which can correspond to the front tube member 16 angle A3 ranging from 70 degrees to 50 degrees. Additionally, the distance L4 can be on the order of 90 inches or less, which can correspond to the front tube member 16 angle A3 ranging from 68 degrees to 50 degrees. These values of angle A3 can provide significant advantages to reducing the overall length of the tandem bicycle 40. Additional clearance advantages can be realized by further angling the end of the fork 28 forward as seen in FIG. 2 such that the travel distance of the rear portion of the rotational plane of the front wheel is reduced as the fork 28 is rotated.

Normal or typical head tube angles of tandem or single bicycles are generally around 72 degrees. A ‘front center’ length can be a length from the front axle 33 to a front bottom bracket. Shorter ‘front center’ lengths can improve handling for tandem bicycles. Typical ‘front center’ lengths with wheel diameters of 20 inches would be around 21-24 inches to be compliant with the Consumer Product Safety Commission (CPSC) section 1512 FIG. 6 with head tube angles of around 72 degrees, while the current disclosure provides a ‘front center’ length of around 17.5 inches that is also compliant with the CPSC 1512 guideline for the same size wheels by changing the head tube angle to 60 degrees and with a 65 mm offset of the bottom of the fork 28. Specifically, head tube angles of 68-55 degrees are preferred for the tandem bicycle of the current disclosure. These angles do not appear to be recognized for the benefit of wheelbase shortening in tandem bicycles while at the same time meeting the requirements of 1512 CPSC FIG. 6 regarding toe interference.

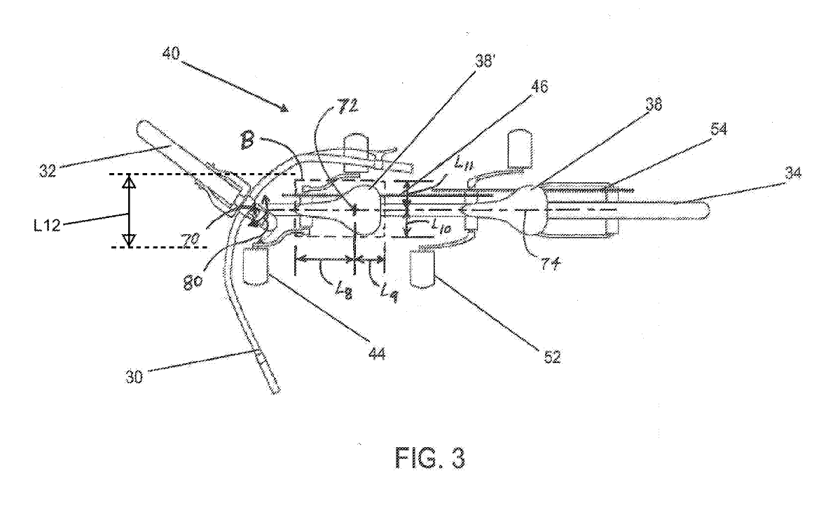

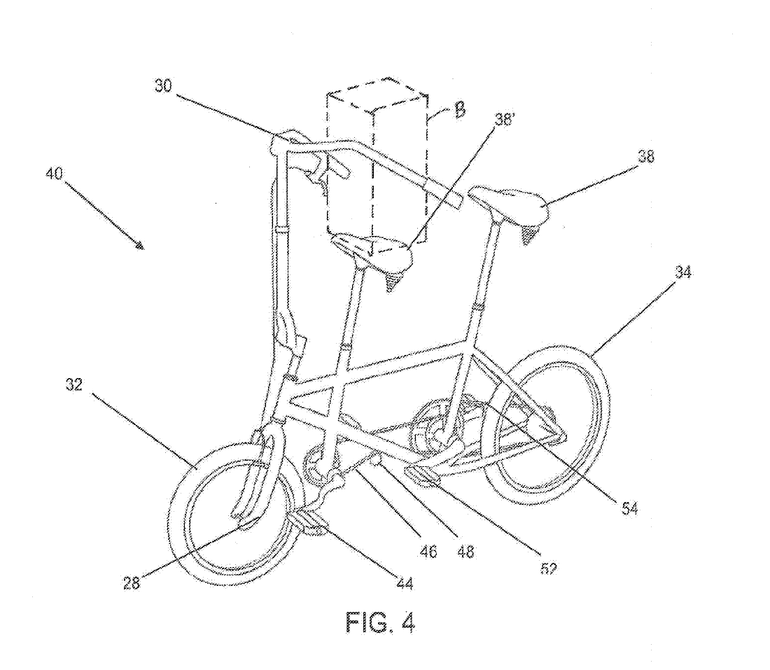

As seen in FIG. 3, the volume B can be positioned such that it is centered side-to-side over the axis 74, with distances L10 and L11 being equal. Of course, it is not a requirement that these distances be equal. Distances L10 and L11 can be different lengths, L10 being the distance from the axis 74 to the left side of the volume B and L11 being the distance from the axis 74 to the right side of the volume B. Therefore, distances L5 thru L11 define the volume B that can be used to generally indicate a position of an upper body of a front rider or cargo. FIG. 4 shows the volume B in a representative perspective view to provide a visualization of a desired positioning of the volume B. L5 can range from 5 inches to 28 inches. L6 can range from 1 inch to 20 inches. L7 can be from 6 inches to 25 inches. L8 can be 4 inches to 9 inches. L9 can be 4 inches to 9 inches. L10 can range from 1 inch to 12 inches. L11 can range from 1 inch to 12 inches.

In other embodiments of the present invention, a tandem bicycle 40 is provided in which the maximal radius of pedals and cranks intersects the front wheel radius. This is particularly advantageous in an inventive bicycle with front wheel of 20 inches or less. It has been surprisingly discovered that when a wheel is intersecting a crank radius, an increase turn angle is realized as a wheel diameter decreases. To facilitate greater limited steering tube angles or no interference (as per CPSC 1512 FIG. 6), such an inventive bicycle can be optionally combined with widened front cranks.

In another embodiment, a tandem bicycle 40 is provided with a total top tube length (Ltotal) shorter than 35 inches which is generally the length of an adult single rider bicycle top tubes and is considerably shorter than conventional tandem bicycles. By way of example, a road race tandem has a top tube length of 46 inches, the BUDDY BIKE™ tandem has a top tube length 37 inches, while single rider bicycles have top tube lengths ranging between 28-19 inches.

In another embodiment, the tandem bicycle 40 is provided with a weight distribution similar to the range of single rider bicycles when the tandem is ridden singularly and from the rear position. The length ratio is derived from front axle 33 to rear seat 38 and back axle 35 to rear seat 38. An inventive tandem bicycle with ratio within 30% of a single rider bicycle ratio is also contemplated.

In another embodiment, the tandem bicycle is provided with a Wheelbase to Rear Crank (WRC) ratio similar to the range of single rider bicycles when the tandem is ridden singularly from the rear position while not similar to the range of taught tandems. The WRC length ratio is derived from the distance between the rear axle 35 and rear crankset 50 center point divided by the distance between front and rear axles 33, 35 (or wheelbase). An inventive tandem bicycle with ratio within 30% of a single rider bicycle ratio is also contemplated. An inventive tandem bicycle has a WRC of 0.28 to 0.42, while in other embodiments; an inventive tandem has a WRC range from of 0.30 to 0.39.

In contrast to the present invention, a, tandem bicycle from UCI road race, short BUDDY BIKE™, and Schwinn short tandem T-5 have WRCs of 0.273, 0.273, and 0.25, respectively; a conventional UCI road race bicycle and Schwinn cruiser bike have WRCs of 0.273 and 0.41, respectively. While tandems with WRC ratios similar to non-tandem bicycles have obvious advantages for handling, and although it might seem obvious careful study shows an increased chainstay length is required to counter the long total top tube or first and second distance of tandem bicycles. Chain stay lengthening is counter intuitive to an already long tandem when ridden as a tandem. It is further counter intuitive when the purpose is to make the tandem for single riders where length reduction is more critical.

Thus, a tandem bicycle is provided that can include front and rear wheels 32, 34, each with an axis of rotation 33, 35, a frame 92 suspended between the front and rear wheels 32, 34. The frame 92 can include a top tube member 18 with a longitudinal axis 74, a head tube member 16 with a longitudinal axis 70, the head tube member 16 being positioned at a front end of the frame 92, a front seat tube member 22′ with a longitudinal axis 72, and a rear seat tube member 22 with a longitudinal axis 76. The tandem bicycle can also include a handle bar 30 positioned at the front end of the frame 92 and rotatably mounted to the head tube member 16, where the head tube longitudinal axis 70 intersects the top tube longitudinal axis 74 at a first intersection, where the front seat tube longitudinal axis 72 intersects the top tube longitudinal axis 74 at a second intersection, where the rear seat tube longitudinal axis 76 intersects the top tube longitudinal axis 74 at a third intersection, and where a total effective top tube distance is a first distance along the top tube longitudinal axis 74 from the first intersection to the third intersection. A second distance along the top tube longitudinal axis 74 can be a portion of the first distance, where the second distance along the top tube longitudinal axis 74 is a distance from the first intersection the second intersection, and where the second distance is less than or equal to 14 inches.

For any of the foregoing embodiments, the tandem bicycle may include any one of the following elements, alone or in combination with each other:

The second distance can be less than less than or equal to one-half the length of the first distance, or less than or equal to one-third the length of the first distance, or less than or equal to one-fourth the length of the first distance, or less than or equal to 6 inches.

The tandem bicycle can include a wheelbase L3 that is a distance L3 between the front wheel axis 33 and the rear wheel axis 35, where the wheelbase L3 is less than or equal to 41.5 inches.

The tandem bicycle can also include a bottom tube member 20, wherein an outer perimeter of the frame 92 is formed by the top 18, the bottom 20, the head 16, and the rear seat 22 tube members. A power transmission can include first and second cranksets 42, 50, where rotation of either one of the first and second cranksets 42, 50 drives the rear wheel 34. The first crankset 42 can be rotatably mounted to an end of a portion of the front seat tube member 22′, and wherein the portion extends outside the outer perimeter. Rotation of either one of the first and second cranksets 42, 50 drives the rear wheel. It should also be understood that either one or both of the first and second cranksets 42, 50 can be replaced with a motor-driven crankset that can be used to drive the rear wheel 34 without a rider pedaling the cranksets 42, 50. In the motor driven version, it may not be necessary (and probably not desired) to have a second crankset incorporated into the tandem bicycle 40. In this confirmation, the rear motor driven crankset 50 would power the tandem bicycle without human interaction, such as pedaling. The motor used to drive the crankset 42 or 50 (or drive the rear wheel 34 directly via a linkage to a sprocket on the rear wheel 34) can be any type of suitable motor for driving the rear wheel 34, such as electric, electro/mechanical, internal combustion, etc.

The front seat tube longitudinal axis 72 can intersect the head tube longitudinal axis 70 at an intersection that is less than 120 inches above a riding surface 8. The front seat tube longitudinal axis 72 can also intersect the head tube longitudinal axis 70 at an intersection that is less than 75 inches above a riding surface 8.

A relative angle A3 between the head tube longitudinal axis 70 and a riding surface 8 can be between 50 degrees and 80 degrees. The relative angle A3 can also be between 55 degrees and 68 degrees.

1Rotation of the front wheel can form a first rotational plane 90 about a rotational axis 33 of the front wheel 32, and with the first rotational plane 90 extending from the rotational axis 33 of the front wheel 32 to an outer diameter of the front wheel 32.

Another embodiment of the tandem bicycle can include a frame 92 suspended between the front and rear wheels 32, 34. The frame can include a top tube member 18, a head tube member 16 positioned at a front end of the frame 92, a front seat tube member 22′, and a rear seat tube member 22, front and rear cranksets 42, 50 can drive the rear wheel, with each one of the front and rear cranksets 42, 50 having an axis of rotation. The front crankset 42 can include left and right pedals 44, where rotation of the left pedal 44 forms a second rotational plane 82, and rotation of the right pedal 44 forms a third rotational plane 84, and where a portion of the first rotational plane 90 is positioned between the second and third rotational planes 82, 84, and the first rotational plane 90 overlaps the second and third rotational planes 82, 84. A perpendicular distance between the second and third rotational planes 82, 84 can determine a maximum diameter of the front wheel 32. Contact between the front wheel 32 and either one of the left and right pedals 44 is avoided when an outer diameter of the front wheel 32 that is less than or equal to the maximum diameter determined by the perpendicular distance between the second and third rotational planes 82, 84.

The tandem bicycle can include a wheelbase L3 that is a horizontal distance L3 between the front wheel axis 33 and the rear wheel axis 35, and a rear crankset distance L13 is a horizontal distance between the axis of the rear crankset 50 and the rear wheel axis 35, where a ratio between the rear crank distance L13 and the wheelbase L3 is between 0.28 and 0.42.

Another embodiment of the tandem bicycle 40 can include front and rear wheels 32, 34, and a frame 92 suspended between the front and rear wheels 32, 34. The frame 92 can include a top tube member 18, a head tube member 16 positioned at a front end of the frame 92, a front seat tube member 22′, and a rear seat tube member 22. The tandem bicycle 40 can also include a handle bar 30 positioned at the front end of the frame 92 and rotatably mounted to the head tube member 16, where the axis 70 of the front seat tube member 22′ intersects the axis 72 of the head tube member 16 at a first intersection, and where the first intersection is less than 120 inches above a riding surface 8. The first intersection could be less than 75 inches above the riding surface 8.

Another embodiment of the tandem bicycle 40 where the front seat 38′ can be mounted to the top tube member 18 (or possibly called a support member 18) by a clamp without a front seat tube member 22′ being utilized. The bicycle 40 can include front and rear wheels 32, 34 with a frame 92 suspended between them that can include a head tube member 16 positioned at a front end of the frame 92, a rear seat tube member 22, and a support member 18 that connects between the head tube member 16 and the rear seat tube member 22. The bicycle 40 can also include a handle bar 30 positioned at the front end of the frame 92 and rotatably mounted to the head tube member 16, where the handle bar 30 is configured to rotate around and outside of a volume B, and the handle bar 30 extends along opposite sides of the volume B (see FIG. 3). The handle bar 30 extends at least partially along each side of the volume B when the front wheel 32 is aligned with the frame 92.

The volume B can be defined by a height L5, a width (L10+L11), and a length (L8+L9), with the volume B being positioned above the support member 18, and along the support member 18 between the head tube member 16 and the rear seat tube member 22, with the volume B being centered over a longitudinal axis 74 of the support member 18 and opposite sides of the volume B being parallel to the longitudinal axis 74, with the volume B extending from above the support member 18 by the height L5, and with the volume extending from 2 inches behind the head tube member 16 by the length (L8+L9). The height L5 can be 5 to 24 inches, the width (L10+L11) can be between 2 and 24 inches, and the length (L8+L9) can be 8 and 18 inches. The frame 92 can include a front seat tube member 22′ that extends into the volume B. A longitudinal axis of the head tube member 16 can extend through the volume B. A front seat can be removably mounted to the support member 18 by a clamp at the mount point 94. A cargo mount can also be removably mounted to the support member 18 by a clamp at the mount point 94.

Although various embodiments have been shown and described, the disclosure is not limited to such embodiments and will be understood to include all modifications and variations as would be apparent to one skilled in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

What is claimed is:

1. A tandem bicycle comprising:
front and rear wheels;
a frame suspended between the front and rear wheels, the frame comprising:
a top tube member with a longitudinal axis,
a head tube member with a longitudinal axis, the head tube member being positioned at a front end of the frame,
a front seat tube member with a longitudinal axis, and
a rear seat tube member with a longitudinal axis; and
a handle bar positioned at the front end of the frame and rotatably mounted to the head tube member,
wherein the head tube longitudinal axis intersects the top tube longitudinal axis at a first intersection,
wherein the front seat tube longitudinal axis intersects the top tube longitudinal axis at a second intersection,
wherein the rear seat tube longitudinal axis intersects the top tube longitudinal axis at a third intersection,
wherein a total effective top tube distance is a first distance along the top tube longitudinal axis from the first intersection to the third intersection,
wherein a second distance along the top tube longitudinal axis is a portion of the first distance,
wherein the second distance is a distance from the first intersection to the second intersection, and
wherein the second distance is less than or equal to 14 inches.

2. The tandem bicycle of claim 1, wherein the second distance is less than or equal to one-half a length of the first distance.

3. The tandem bicycle of claim 1, further comprising a power transmission that includes first and second cranksets, wherein rotation of either one of the first and second cranksets drives the rear wheel.

4. The tandem bicycle of claim 1, wherein a relative angle between the head tube longitudinal axis and a riding surface is between 50 degrees and 70 degrees.

5. The tandem bicycle of claim 4, wherein the relative angle is between 55 degrees and 68 degrees.

6. A tandem bicycle comprising:
front and rear wheels, with rotation of the front wheel forming a first rotational plane about a rotational axis of the front wheel, and with the first rotational plane extending from the rotational axis of the front wheel to an outer diameter of the front wheel;
a frame suspended between the front and rear wheels;
front and rear cranksets which drive the rear wheel, with each one of the front and rear cranksets having an axis of rotation,
wherein the front crankset includes left and right pedals, wherein rotation of the left pedal forms a second rotational plane, and rotation of the right pedal forms a third rotational plane, and
wherein a portion of the first rotational plane is positioned between the second and third rotational planes, and the first rotational plane overlaps the second and third rotational planes.

7. The tandem bicycle of claim 6, wherein a perpendicular distance between the second and third rotational planes determines a maximum diameter of the front wheel.

8. The tandem bicycle of claim 7, wherein contact between the front wheel and either one of the left and right pedals is avoided when an outer diameter of the front wheel is less than or equal to the maximum diameter determined by the perpendicular distance between the second and third rotational planes.

9. The tandem bicycle of claim 6, wherein a wheelbase is a horizontal distance between a front wheel axis and a rear wheel axis, and a rear crankset distance is a horizontal distance between the axis of the rear crankset and the rear wheel axis, wherein a ratio between the rear crank distance and the wheelbase is between 0.28 and 0.42.

10. The tandem bicycle of claim 6, wherein the frame comprises:
a top tube member,
a head tube member positioned at a front end of the frame,
a front seat tube member, and
a rear seat tube member.

11. A tandem bicycle comprising:
front and rear wheels;
a frame suspended between the front and rear wheels, the frame comprising:
a top tube member,
a head tube member positioned at a front end of the frame,
a front seat tube member, and
a rear seat tube member; and
a handle bar positioned at the front end of the frame and rotatably mounted to the head tube member, wherein a longitudinal axis of the front seat tube member intersects a longitudinal axis of the head tube member at a first intersection, and wherein the first intersection is less than 120 inches above a riding surface.

12. The tandem bicycle of claim 11, wherein the first intersection is less than 75 inches above the riding surface.

13. The tandem bicycle of claim 11, wherein a relative angle between a longitudinal axis of the head tube member and a riding surface is between 68 degrees and 55 degrees.

14. A bicycle comprising:
front and rear wheels;
a frame suspended between the front and rear wheels, the frame comprising:
a head tube member positioned at a front end of the frame,
a rear seat tube member, and a support member that connects between the head tube member and the rear seat tube member; and
a handle bar positioned at the front end of the frame and rotatably mounted to the head tube member, wherein the handle bar is configured to rotate around and outside of a volume, and the handle bar extends along opposite sides of the volume,
wherein the volume is defined by a height, a width, and a length, with the volume being positioned above the support member, and along the support member between the head tube member and the rear seat tube member, with the volume being centered over a longitudinal axis of the support member and the opposite sides being parallel to the longitudinal axis, with the volume extending from 1 to 20 inches above the support member by the height, and with the volume extending from 2 inches behind the head tube member by the length, and
wherein the height is from 5 to 28 inches, the width is from 2 to 24 inches, and the length is from 8 to 18 inches.

15. The bicycle of claim 14, wherein the height is from 5 to 20 inches, the width is from 6 to 18 inches, the length is from 8 to 18 inches, and the volume extends from 1 to 10 inches above the support member by the height.

16. The bicycle of claim 14, the frame further comprising a front seat tube member that extends into the volume.

17. The bicycle of claim 14, wherein a longitudinal axis of the head tube member extends through the volume.

18. The bicycle of claim 14, wherein a front seat is removably mounted to the support member at a mount point 94.

19. The bicycle of claim 14, wherein a cargo mount is removably mounted to the support member at a mount point 94.
